(19) United States
(12) Patent Application Publication
(10) Pub. No.: US 2005/0098766 A1
(43) Pub. Date: May 12, 2005

(54) Chemiluminescent processes and systems

(76) Inventors: David L. Watson JR., Fripp Island, SC (US); Orville Z. Tyler, Mt. Pleasant, SC (US)

Correspondence Address: B. Craig Killough;Barnwell Whaley Patterson & Helms, LLC, P.O. Drawer H, Charleston, SC, 29402, US

(21) Appl. No.: 10/452,377

(22) Filed: Jun. 2, 2003

Related U.S. Application Data
(60) Provisional application No. 60/411,973, filed on Sep. 19, 2002.
(60) Provisional application No. 60/445,775, filed on Feb. 6, 2003.
(60) Provisional application No. 60/448,421, filed on Feb. 17, 2003.

(51) Int. Cl. C09K 11/00

(52) U.S. Cl. 252/700

(57) ABSTRACT

A chemiluminescent system that will produce visible light for an extended period of time, without the use of relatively high levels of oxidizing agents that are non-reacting within the system. The chemiluminescent system comprises a chromophore, an activator, and a granular metering agent, or a chromophore and/or an activator that acts as a granular metering agent. The chromophore will produce visible light when reacted with the activator.

### FIELD OF THE INVENTION

This invention relates to chemiluminescent systems and processes for producing visible light by chemical reaction.

### BACKGROUND OF THE INVENTION

Chemiluminescence is the production of light energy from the chemical reaction of components of a chemiluminescent system. Two common subclasses of chemiluminescence are bioluminescence, wherein light is produced by chemical reactions involving organisms, and oxiluminescence, wherein light is produced by chemical reactions between oxygen and a chromophore, which may be organic or inorganic.

Various oxyluminescent compounds are known and used. Examples of oxyluminescent compounds are described in U.S. Pat. Nos. 4,313,843, 4,678,608, 4,717,511, and 5,122,306. Most commonly, compounds that will produce visible light are reacted with hydrogen peroxide to produce the desired chemiluminescence. In a common embodiment of a chemiluminescent system, hydrogen peroxide is present in, for example, a 2:1 or 3:1 ratio (by volume) with an agent that reacts with the hydrogen peroxide to produce visible light. Accordingly, there is a relatively large amount of hydrogen peroxide present in the chemiluminescent system. If the chemiluminescent system comes into contact with hair, or other articles that are subject to degradation by oxidation, the chemiluminescent system as described will have an oxidizing and/or bleaching effect that is undesired, and potentially harmful.

Prior art chemiluminescent systems are solutions, suspensions or perhaps, colloids or emulsions. These liquid systems typically have a viscosity that is 50 centipoise or less, and require a container that will contain liquids to be usable.

A commercial product that employs oxyluminescence is the Glowstick® lightstick produced by Omniglow. The lightstick is manipulated to introduce hydrogen peroxide to a chromophore contained in the lightstick, so that visible light is produced by the reaction between the hydrogen peroxide and the chromophore. The lightstick typically contains about 2 ml of luminescent material and 6 ml of hydrogen peroxide activator. This quantity of chemiluminescent compound will produce visible light for approximately 4 to 12 hours.

There is a need to provide a chemiluminescent system that will reduce the relative quantity of potentially harmful peroxides or other oxidizing agents, so that the harmful effects of the oxygen available for reaction are reduced, and the amount of excess oxygen that comes into contact with hair or skin, oxidation sensitive substrates, or other materials or surfaces that may be harmed by elemental oxygen is controlled. There is also a need to produce a chemiluminescent system that will provide visible light for periods of time that are longer than chemiluminescent systems known and used in the prior art, while not increasing the relative quantity of chromophore or chromophore that is present in the chemiluminescent system. The chemiluminescent system should be capable of use with, or without, a container.

### SUMMARY OF THE PRESENT INVENTION

The present invention is a chemiluminescent system that will produce visible light for an extended period of time, without the use of relatively high levels of oxidizing agents that are non-reacting within the system. The chemiluminescent system comprises a chromophore, an activator, and a granular metering agent, or a chromophore and/or an activator that acts as a granular metering agent. The chromophore will produce visible light when reacted with the activator.

### DETAILED DESCRIPTION OF THE PREFERRED EMBODIMENT

The preferred embodiment is a chromophore, and more specifically, an oxyluminescent system comprising a chromophore that will yield visible light upon reacting with an activator. In a preferred embodiment, the chromophore is chosen from a group of anthracene dyes together with oxalate esters or 1,2-dioxetanes. A vehicle that is an activator may include a peroxide, and will provide oxygen to the system. The activator may be hydrogen peroxide.

The invention comprises one or more additional materials that increase the time period over which the chemiluminescent system will yield visible light when compared to the same system without the additional material. The one or more additional materials also control the activator that is provided within the system to produce visible light from the chromophore for an exteneded period of time. The one or more additional materials are defined as a metering agent. Metering agents that are useful in the invention are crystalline, solid elements or compounds that are granular. A reducing agent, and/or a catalyst for accelerating the reaction, may also be included.

In one embodiment, cornstarch is the metering agent. Upon introduction of the activator, which may be hydrogen peroxide, to the cornstarch, the hydrogen peroxide is absorbed by the granular cornstarch in a random fashion.

If used, the amount of polar liquid (e.g., water, various alcohols) that contacts the granular metering agent is particularly important. Normally, optimum chemiluminescent properties are achieved when the liquid levels are no more than 5% to 30% of the total composition, so that the cornstarch or other metering agent is 70% to 95% of the total weight of the chemiluminescent system, and the components are mixed to viscosities that allow the metering agent to retain granular, rather than sorptive, properties. The polar liquid may be used at higher levels provided that the polar liquid is combined with highly sorptive materials such as an acrylic, or gum agar, prior to the introduction of the chromophore and oxidizer. In other words, the viscosity of the polar liquid must be materially increased prior to the introduction of the reactive components.

The chromophore, or a by product of the reacted chromophore, stays on the surface of the metering agent, due to the molecular weight and nonpolar nature of the metering agent, and is adsorbed by the metering agent. The reaction, or further reaction, between the chromophore and the activator produces visible light, with the intensity of the light increasing over time to a maximum sustainable level. The metering agent effectively meters the reagents, which results in the strengthening of the intensity of the light over time until it reaches a maximum. A stable maximum is sustained for some period of time, then gradually declines.

The metering agent is granular. “Granular” as used herein means a material that comprises small solid particles of crystalline structure, wherein the particles are either (1) insoluble or sparingly soluble in any of the liquid component(s) of the chemiluminescent system, or (2) if soluble in the liquid component(s), the liquid components are present in, an insufficient quantity to solubilize a substantial portion of the metering agent, or (3) the liquid component(s) are in a form that will not materially solubilize the particles, such as a thickener. For example, if the liquid is thickened prior to introduction of the particles, the liquid component is not in a form that will materially solubilize the granular particles. This is important since, in order for metering of the reacting compounds to take place, they must be absorbed, or there must be a combination of adsorption/absorption by the granular compound, and therefore, the metering agent(s) must be present in a granular form, and not in the form of a liquid. The granular metering agent is present in a sufficient quantity and has properties such that the chemiluminescent system as produced, when taken as a whole, is not characterized as a solution, a suspension, a colloid or an emulsion, although individual components may fall within one or more of these categories.

In the present invention, the chromophore and the activator may be present in relatively low quantities as a percentage of the overall system as compared to, for example, GLOWSTICK® lightsticks produced by Omniglow, wherein the chromophore and hydrogen peroxide are instantly mixed upon breaking of the containers of the reagents within the lightstick. While the metering agent in some embodiments of the present invention initially absorbs and/or adsorbs the hydrogen peroxide, the oxygen will come to the surface of the metering agent over time, where the oxygen reacts with and activates the chromophore. The metering agent will also absorb moisture from the air. In this case, the polar nature of the water, and the peroxide, align the reactive ions on the surface of the metering agent in a uniform manner, allowing the luminescent action to strengthen. This result is superior to the use of hydrogen peroxide alone as an activator. The surface activity of the metering agent provides a physical system that improves the longevity of the luminescence of the system, while at the same time controlling the quantity of oxidizing agent that is required for the reaction. It is also possible to reduce the amount of chromophore relative to the activator that is necessary to obtain or exceed the same level of luminescence, as compared with known liquid chemiluminescent systems.

The absorption of the activator by the granular metering agent shields the activator by attachment of the activator to the metering agent. The absorbed activator is shielded from the chromophore so that the activator is slowly introduced to the chromophore as the activator escapes from the metering agent over time. The use of the cornstarch as a metering agent slows the reaction between the chromophore and the activator, thereby yielding luminescence over a substantially extended period, as compared to the use of a non-granular chromophore and a non-granular activator, without a metering agent. The metering agent reduces the amount of oxygen that is available for undesired reaction, such as oxidation of the hair or skin. Even if an initial reaction between the reagents yields a by-product that interferes with subsequent reaction, surface adsorption of the by-product appears to allow the primary reaction to continue unfettered, and more efficiently, than if the metering agent were absent.

While sugars and cornstarch may be used as metering agents, other granular materials will perform as metering agents. Further, at least some silicone, petroleum wax based, and gelatinous materials are suitable metering agents. The following compounds have demonstrated the ability to improve the period of luminescence and reduce the required quantity of oxidizing agent, or they accelerate the maximum luminescence, consistent with the objects of the invention: HASK® pure shine frizz remedy; KY® jelly; CREATINE®; NEUTROGENA® clear pore astringent; REMBRANDT'S® Plus Whitening Gel; 2-methoxyethyl ether; 2-methyl-2-propanol; 3-methyl-3-pentanol; JHERRI REDDING® alcohol-free shine gel; PRO VITAMIN® (TODD CHRISTOPHER); Phosphite buffered saline solution; Sodium Laurel Sulfonate. Rembrandt's Plus Whitening Gel is commercially sold as a tooth whitener, and as is common with tooth whiteners, this substance contains peroxide that will function as an activator. Compounds having surface active, deliquescent properties, like cornstarch or sugars, have properties that will meet the objects of the present invention.

Inorganic agents shown to perform as metering agents include finely divided carbon or silica based compounds, such as carbonates or silicates. Preferred inorganic metering agents are silica sand, silica glass and silica gel.

### EXAMPLE 1

| | |
|---|---|
| Component A | 1 to 2 ml chemiluminescent chromophore and 30 to 40 |
| | grams cornstarch mixed to granular paste. |
| Component B | 6 ml of 3% hydrogen peroxide solution, or 12 grams of |
| | 11% hydrogen peroxide paste, 80 to 120 grams |
| | cornstarch mixed to granular paste. |

Example 1 adds a metering agent to a known liquid chemiluminescent formula, such as the liquid used in a lightstick. Component A and Component B are stored or contained separately at room temperature. Component A should be stored in an opaque container. In use, the components are mixed by stirring, and combined until luminescence appears. Light will be produced by the reaction of the components, and has been observed to last from 6 to 198 hours of more depending on the amount of activator in Component B.

Example 1 yields a non-liquid chemiluminescent composition. The non-liquid chemiluminescent composition does not require a container, although one may be used, and the composition may be used in the “open air,” unlike liquid chemiluminescent compositions that are contained in sealed containers.

### EXAMPLE 2

| | Grams |
|---|---|
| Rubene Dye | .08 |
| Methyl Salicylate | .20 |
| Powdered and Granular Sugar | 1.00 |
| Cornstarch | 1.00 |
| *PVA, 35% in water | 6.00 |
| CPPO Oxalate | 4.00 |
| Carbamide Peroxide | 4.00 |
| Sodium Silicate/Sodium Hydroxide | 1.60 |
| TOTALS | 17.88 |

May include up to 1% ammonia.

Example 2 comprises a liquid chemiluminescent chromophore formed by dissolving a chromophore into a solvent, such as methyl salicylate. The resulting solvent is combined with a metering agent. The metering agent is solid and absorptive, and is preferred to be adsorptive. The metering agent can be a starch, a sugar or a combination, such as a combination of powdered sugar and cornstarch. A particularly effective metering agent is a blend of granular sugar and powdered sugar, which may be mixed in a 1:1 ratio. These materials have the desired absorptive properties, in that the individual particles will absorb the liquid dye, while adsorption by the entire quantity of these materials also occurs.

An activator is prepared. The activator of Example 2 provides oxygen to the dye to cause the dye to luminesce. The activator is a peroxide and an oxalate. The peroxide may be hydrogen peroxide, but in one embodiment, it is carbamide peroxide (urea peroxide), which is a solid. The carbamide peroxide is mixed with a catalyst, which is preferred to be a non-acid catalyst, and may be sodium hydroxide or anhydrous ammonia, or a combination, to form the activator.

The catalyst accelerates the reaction with the chromophore and reduces the chemiluminescent initiation time. Hydroxyl ion catalysis is a material part of the catalyst function. A broad range of bases and salts may provide the essential hydroxyl ions. A combination of carbamide peroxide and polyvinyl alcohol (PVA) may be combined with the catalyst.

Elmer's® glue may replace PVA or be used with PVA to control viscosity. Acrylic thickeners, such as CARBOPOL® 940, or organic thickeners, such as guar gum, may be used to produce desired viscosity, when a gel or other viscous chemiluminescent system is desired.

The activator is introduced to the chromophore that is absorbed and adsorbed by, and attached to, the metering agent. The activator provides oxygen to cause the chromophore to luminesce. The metering agent yields dye to the activator over time, so that chemiluminescence is prolonged for multiple hours or multiple days. The use of a relative high quantity of metering agent relative to the dye will prolong the period of luminescence. Reducing the quantity of metering agent reduces the period of luminescence.

Sodium hydroxide (NaOH) alone may be used in the formula, rather than a sodium silicate sodium hydroxide blend. NaOH may be diluted to 5% or less so that irritation does not occur if the material comes in contact with skin or is topically applied.

### EXAMPLE 3

| | Grams |
|---|---|
| Chromophore | 0.08 |
| Methyl Salicylate | 0.06 |
| Phenethyl Acetate | 0.15 |
| Carbamide peroxide | 1.85 |
| CPPO Oxalate | 1.85 |

One or more of the reactive ingredients, such as the activator, may serve as the metering agent. In Example 3, the activators, carbamide peroxide and CPPO oxalate are also granular metering agents. The dissolved, or partially dissolved, dye components are adsorbed on the outside on the particles that comprise the granular activators and metering agents. The granular components can be either a peroxide, or an oxalate, or a combination of peroxide and oxalate. When the granular oxalate and the granular peroxide, such as carbamide peroxide, are combined, the combination generates a strong, long-lasting chemical light. Optionally, an equal amount of disodium oxalic acid may be substituted for CPPO oxalate to adjust granularity.

### EXAMPLE 4

| Item | Percent | CAS Number |
|---|---|---|
| Part A | | |
| Chromophore | 0.75 | 51749-83-8 |
| Phenethyl Acetate | 1.36 | 103-45-7 |
| Methyl Salicylate | 1.42 | 119-36-8 |
| Inert Filler 1 | 22.05 | None |
| Carbamide Peroxide | 22.05 | 124-43-6 |
| Part B | | |
| CPPO Oxalate | 30.00 | 75203-51-9 |
| Inert Filler 1 | 19.08 | None |
| Inert Filler 2 | 1.09 | None |
| Sodium Silicate Blend | 2.20 | 1344-09-8 |
| Total | 100.00 | |

Example 4 has a Part A and Part B that emit light when mixed. Example 4 produces a solid granular chemiluminescent system that may be used to illuminate an area, such as a room, when broadcast over the area. Alternatively, the material may be fired at, or over, a person, animal or object at night, allowing the person animal, or object that receives the material to be visually tracked without the use of special goggles.

All materials are preferred to be 95 to 99% pure and are in granular form, excepting that phenethyl acetate and methyl aalicylate are liquids. The sodium silicate is a blend of 27% sodium silicate and 17% sodium hydroxide in water.

The phenethyl acetate dissolves the chromophore. The methyl salicylate helps to disperse the chromophore solution over the inert filler. The inert filler allows the granular chemiluminescent system to be broadcast over an area and evenly dispersed. Inert filler 1 may be silica sand. Inert filler 2 may be silica glass.

Upon introduction of Part B, the CPPO oxalate activates the chromophore to produce chemiluminescence. The carbamide peroxide also functions as an activator, but will not initiate the reaction without the presence of the CPPO oxalate. The sodium silicate blend of 27% sodium silicate and 17% sodium hydroxide in water is a catalyst for the reaction, which combines with the methyl salicylate in Part A to speed the distribution of the catalyst across the surface of the granular materials so that Part A and Part B react in combination.

### EXAMPLE 5

| Item | Percent | CAS Number |
|---|---|---|
| Part A | | |
| Chromophore | 0.19 | 51749-83-8 |
| Phenethyl Acetate | 0.38 | 103-45-7 |
| Methyl Salicylate | 0.38 | 119-36-8 |
| Carbopol 940, 1.5% | 35.00 | 9003-01-4 |
| Carbamide Peroxide | 13.80 | 124-43-6 |
| Part B | | |
| CPPO Oxalate | 15.25 | 75203-51-9 |
| Carbopol 940, 1.5% | 35.00 | 9003-01-4 |
| Total | 100.00 | |

Example 5 is comprised of Part A and Part B that emit light when mixed. Example 5 is a solid system that is contained in a gelatinous material. This embodiment may be used as a novelty hair gel that is light emitting.

All materials are 95 to 99% pure and are in granular form, excepting that phenethyl acetate and methyl salicylate are liquids. The sodium silicate is a blend of 27% sodium silicate and 17% sodium hydroxide in water. CARBOPOL® 940 is an acrylic thickener in water. The reaction between the chromophore and the activator takes place as described in Example 4. The CARBOPOL® 940, having been previously dispensed at 1.5% in water, functions as a metering agent by allowing a portion of the reactants and the reaction products to adsorb on its surface. The reaction gradually extinguishes over time by the collection of atmospheric elements on the surface of the metering agents, including the CARBOPOL® 940 particles. Simple stirring uncovers metering agent particles that have adsorbed and/or absorbed the chromophores, and have not been previously subjected to atmospheric elements, such as water and oxygen, and the reaction is again initiated.

In each Example, after the ingredients are combined, and the mixture is dispersed, light is emitted from the particulate. The light is sustained independently in varying intensity, depending on the ratio of ingredients that are adsorbed and/or absorbed by the granular particles. A further embodiment allows for completely inert ingredients, such as sand, particle glass and/or silica gel, to dilute the overall mix, and make it disperse more evenly.

Further, in each Example, after a period of time, the light intensity will diminish. Stirring or shaking the material, whether it is in a gel or solid form, will reactivate the light emission properties of the composition. The invention disclosed herein has vastly improved longevity over the liquid chemiluminescent materials found in the prior art, such as the liquid materials used in light sticks.

This invention represents several major advantages over previously known chemluminescent compositions, such as those used in light sticks. These advances include:
1. The reaction will proceed in the open air, and it is not necessary to employ a closed container, or in some applications, any container at all.
2. The chemical components, and the resulting system, are much less toxic.
3. Objectionable organic solvents that have odor and staining properties have been eliminated or reduced to relatively harmless quantities.
4. The ability to reactivate, so as to extend the life of the system, or to intensify, the chemiluminescence of the system, subsequent to initial reaction.

1. A chemiluminescent system comprising a chromophore, an activator, and a granular metering agent, wherein said chromophore is adsorbed by said granular metering agent.

2. A chemiluminescent system comprising a chromophore, an activator, and a granular metering agent, wherein said chromophore is absorbed by said granular metering agent.

3. A chemiluminescent system as described in claim 2, wherein a portion of said chromophore is absorbed by said granular metering agent and a portion of said chromophore is adsorbed by said granular metering agent.

4. A chemiluminescent system comprising a chromophore, an activator, and a granular metering agent, wherein at least a portion of said granular metering agent is not solubilized within said chemiluminescent system.

5. A chemiluminescent system as described in claim 1, wherein the chemiluminescent system is a solid, granular material.

6. A chemiluminescent system as described in claim 2, wherein the chemiluminescent system is a solid, granular material.

7. A chemiluminescent system as described in claim 1, wherein the chemiluminescent system is not a liquid.

8. A chemiluminescent system as described in claim 2, wherein the chemiluminescent system is not a liquid.

9. A chemiluminescent system as described in claim 1, wherein the chemiluminescent system is not a suspension.

10. A chemiluminescent system as described in claim 2, wherein the chemiluminescent system is not a suspension.

11. A chemiluminescent system as described in claim 1, wherein the chemiluminescent system is not a colloid.

12. A chemiluminescent system as described in claim 2, wherein the chemiluminescent system is not a colloid.

13. A chemiluminescent system as described in claim 1, wherein the chemiluminescent system is not an emulsion.

14. A chemiluminescent system as described in claim 2, wherein the chemiluminescent system is not an emulsion.

15. A chemiluminescent system as described in claim 1, wherein said chromophore and said activator are solids.

16. A chemiluminescent system as described in claim 2, wherein said chromophore and said activator are solids.

17. A chemiluminescent system as described in claim 4, wherein said chromophore acts as said granular metering agent.

18. A chemiluminescent system as described in claim 1, wherein said activator acts as said granular metering agent.

19. A chemiluminescent system as described in claim 2, wherein said activator acts as said granular metering agent.

20. A chemiluminescent system as described in claim 3, wherein said activator acts as said granular metering agent.

21. A chemiluminescent system as described in claim 1, wherein the chemiluminescent system comprises no more than thirty (30%) percent liquid.

22. A chemiluminescent system as described in claim 2, wherein said chemiluminescent system comprises no more than thirty (30%) percent liquid.

23. A chemiluminescent system as described in claim 3, wherein said chemiluminescent system comprises no more than thirty (30%) percent liquid.

24. A chemiluminescent system as described in claim 1, wherein said chemiluminescent system comprises a polar liquid and a sorptive material, and wherein said sorptive material increases a viscosity of said chemiluminescent system.

25. A chemiluminescent system as described in claim 2, wherein the chemiluminescent system comprises no more than thirty (30%) percent liquid.

26. A chemiluminescent system as described in claim 1, wherein said chemiluminescent system comprises more than 20% liquid and said chemiluminescent system further comprises a sorptive material for increasing viscosity of the chemiluminescent system.

27. A chemiluminescent system as described in claim 2, wherein said chemiluminescent system comprises more than 20% liquid and said chemiluminescent system further comprises a sorptive material for increasing viscosity of the chemiluminescent system.

28. A method of producing light by chemiluminescence, comprising the steps of:
combining a chromophore, an activator, and a granular metering agent to create a chemiluminescent system, wherein said chemiluminescent system produces visible light; and
subsequently, and at a remote time from combining said chromophore, said activator, and said granular metering agent to create said chemiluminescent system, agitating said chemiluminescent system to increase a level of emission of visible light from said chemiluminescent system.

29. A method of producing light by chemiluminescence as described in claim 28, wherein said chemiluminescent system is a solid.

30. A method of producing light by chemiluminescence as described in claim 25, wherein said chemiluminescent system comprises no more than 30% liquid.

31. A method of producing light by chemiluminescence as described in claim 25, wherein said chemiluminescent system comprises more than 20% liquid, and said chemiluminescent system further comprises a sorptive material for increasing the viscosity of the chemiluminescent system.
